(19) United States
(12) Patent Application Publication
(10) Pub. No.: US 2017/0254246 A1
(43) Pub. Date: Sep. 7, 2017

(54) HEATING DEVICE FOR A MOTOR VEHICLE OPERATING FLUID TANK WITH A PTC PLASTIC ELEMENT

(71) Applicant: Röchling Automotive SE & Co. KG, Mannheim (DE)

(72) Inventors: Fabrizio CHINI, Isera (TN) (IT); Luca MARINI, Besenello (TN) (IT); Ivan DE METRI, Bolzano (BZ) (IT); Francesca BRUNORI, Laives (BZ) (IT); Stefano DALPEZ, Male (TN) (IT)

(73) Assignee: Röchling Automotive SE & Co. KG, Mannheim (DE)

(21) Appl. No.: 15/444,985

(22) Filed: Feb. 28, 2017

(30) Foreign Application Priority Data
Mar. 3, 2016 (DE) 10 2016 203 497.9

(51) Int. Cl. F01N 3/28; H05B 3/00; F01N 3/20; H05B 1/02

(52) U.S. Cl. CPC F01N 3/2896; H05B 1/0236; H05B 3/0014; F01N 3/206

(57) ABSTRACT

A heating device (10) for a motor vehicle operating fluid tank, in particular for storing aqueous urea solution, wherein the heating device (10) has two electrical conductors (12, 14), an element (16) made from PTC plastic, which is electrically arranged between the two electrical conductors (12, 14) and is in electrical contact with the two electrical conductors (12, 14), and a shell (18, 20), which protects the electrical conductors and the PTC plastic element (16) from the outside environment (22) at least in some sections, which is characterized in that at least one electrical conductor (12, 14) is made at least in some sections from a metal foil (12, 14), in particular aluminum foil, and that the shell (18, 20) is an insulating surface, in particular a plastic film (18, 20) that is preferably bonded to the metal foil.

### CROSS REFERENCE TO RELATED APPLICATION(S)

This application claims priority to German Application No. 10 2016 203 497.9, filed Mar. 3, 2016. The entirety of the disclosure of the above-referenced application is incorporated herein by reference.

### BACKGROUND OF THE INVENTION

Field of the Invention

The present invention relates to a heating device for a motor vehicle operating fluid tank, in particular for storing aqueous urea solution, wherein the heating device has two electrical conductors, an element made of PTC plastic arranged between the two electrical conductors and in electrical contact with the two electrical conductors, and a shell that protects the electrical conductors and the PTC plastic element at least partially from the outer environment.

The invention likewise relates to a motor vehicle operating fluid tank, in particular for storing aqueous urea solution, having a filling opening, a removal opening different from the filling opening, and a heating device such as this.

Description of the Related Art

A generic heating device is known, for example, from DE 10 2013 209 957 A1. The generic heating device has two contact pins, one for each electrical pole, each of which is encased by electrically conducting plastic. The two electrical plastic formations encasing the contact pins are in electrical contact with a PTC-element arranged between the two. The assembly configured in this way by two plastic plates of electrically conducting plastic with contact pins accommodated therein and the PTC-element arranged between the contact plates is encased by an electrically insulating but heat conducting plastic material that protects the electrically conducting plastic plates and the PTC-element arranged between them from outside influences.

PTC-elements are components that heat up when an electric current flows through them and can release heat to the outside environment because of the temperature gradients produced by the heating. “PTC” means herein “Positive Temperature Coefficient,” which indicates that the electrical resistance of the PTC-element increases with rising temperature. This leads to a desirable self-limiting of heating power of a PTC-element. Since the electrical resistance of the PTC-element also increases with rising temperature, the current flow through the PTC-element diminishes with increasing temperature because of the rising resistance, so that the quantity of heat released by a PTC-element per unit of time becomes ever smaller with a rising temperature of the PTC-element. This can ensure that the PTC-element or the medium that is to be heated by it does not overheat.

The chemical stability of the aqueous urea solution of special interest here decreases at temperatures of more than 80° C., so that its safety of use at high temperatures is greatly endangered. For this reason, the PTC-elements that self-regulate with regard to their heating capacity with rising temperature are especially suited for the heating of aqueous urea solution, but also of other operating fluids.

### SUMMARY OF THE INVENTION

It is an object of the present invention to further develop the generic heating device in such a way that it can be configured with the smallest possible thickness so that it can be arranged in a motor vehicle operating fluid tank with the greatest possible heat-emitting surface, without requiring excessive storage volume in the operating fluid tank.

This object is attained according to a first viewpoint of the present invention by means of a heating device of the initially mentioned type, in which at least one electrical conductor is made at least in part of metal foil, in particular aluminum foil, and in which the shell is an insulating surface.

The insulating surface is preferably connected to the metal foil, although this is not absolutely necessary. Especially if the metal foil is configured with a greater thickness, for example, more than 1 mm, the insulating surface can be provided as an insulator plate component without adhesive bonding to the metal foil. On the other hand, as is basically preferred, if the insulating surface is bonded to the metal foil, this can be done by spraying the metal foil with thermoplastic material or by applying and allowing to cure a lacquer made of insulating material, in particular electrically non-conducting plastic. The insulating surface is preferably formed by a plastic film. The invention will be described in more detail below with reference to the preferred embodiment of a plastic film bonded to a metal foil. It should however be pointed out that the above-mentioned alternative embodiments can also be used instead. The metal foil is particularly preferably an aluminum foil. This does not rule out, however, that stainless steel could be used as metal for the metal foil, in particular if the foil thickness is in the upper range of the below-mentioned total thickness range, which can still be understood at present as foil.

An aluminum foil is here preferred as metal foil due to the self-passivation for reasons of corrosion protection. With “foil” is meant in particular a thickness of the metal of between 10 μm and 2 μm, preferably 10 to 80 μm, in particular 10 to 50 μm. A heat-emitting surface, which extends over a large surface and is still light and thin, can therefore be obtained with this metal foil.

The heating device obtains its stiffness as a result of the PTC plastic element, which preferably has a thickness of between 100 and 5000 μm, in particular between 300 and 2000 μm, and preferably approximately 500 μm.

The protective shell is hereby preferably a plastic film made, for example, from polyolefin, especially preferably polypropylene, which can likewise have a thin configuration, for example, within the range of 150 to 400 μm, especially 200 to 300 μm, preferably approximately 250 μm.

The plastic film is preferably bonded to the conductor section which is configured as a metal foil, since this can significantly facilitate the handling of the thin, and therefore as a rule non-rigid, metal foil during manufacture of the heating device.

Preferably not only one section of the electrical conductor, but the entire conductor, is configured as a metal foil. The heating device is further preferably configured in layers in the thickness direction and comprises, inwardly from outside the plastic film, the metal foil, the PTC plastic element, the additional electrical conductor, and again the plastic film.

The section of the electrical conductor made from metal foil can be either a continuous full-surface foil section or can be configured as a meandering conductor path.

Various production processes exist for the production of the PTC plastic element. The PTC plastic element can be formed, for example, by extrusion or/and by injection molding. The PTC plastic element can likewise be possibly formed from a semi-finished product by means of thermoforming, wherein a plate-like semi-finished product is preferred for reasons of the desired lesser thickness of the heating device. Three-dimensionally shaped laminar PTC plastic elements can be formed both by means of injection molding as well as thermoforming, wherein “laminar” indicates herein that the respective plastic element has a substantially smaller dimension than in its orthogonal extension directions both toward the thickness direction and toward each other.

The PTC behavior of the material used for the plastic element can be achieved, for example, by filling a thermoplastic material with the corresponding electrically conducting filling material, for example, granular particles or fiber particles.

In order to achieve the best possible bond between the section of the electrical conductor made from metal foil and the plastic film, an adhesive can be applied between them, wherein preferably an electrically conducting adhesive is used. The section of the electrical conductor made from metal foil can alternatively or additionally be bonded to the plastic film by means of a vacuum.

The PTC plastic element can also be formed by co-extrusion with a metal foil in addition to the above processes, so that the PTC plastic is extruded directly onto the metal foil. The co-extrusion of metal foil(s) and PTC plastic is known per se from the prior art.

The PTC plastic is preferably co-extruded between two metal foils, so that a sandwich component with outer metal foils and a PTC plastic element arranged between them is obtained. In this case, both electrical conductors are made from metal foil, which is basically preferred independently of the selected production process.

It may be considered, according to an advantageous embodiment of the present invention, to apply electrically conducting material at least on one side of the PTC plastic element that faces an electrical conductor in order to improve the electrical contact between an electrical conductor and the PTC plastic element. The electrically conducting material may be identical to the material used in the PTC plastic element or it may differ from it. A metal is preferably applied as the electrically conducting material, which is carried out especially by means of a precipitation method. A chemical or a galvanic precipitation can also be conceived herein, wherein the chemical precipitation can also be carried out from the gas phase. A physical gas phase precipitation of the metal onto a surface of the PTC plastic element is additionally conceivable. In the case where a precipitation process is used, the thickness of the applied electrically conducting material can be within the nanometer range, for example in the two-digit nanometer range.

The electrically conducting material can likewise be applied as a liquid or paste-like electrically conducting substance onto a surface of the PTC plastic element. The thickness of the electrically conducting material can then be within the three-digit micrometer range. The thickness of the applied electrically conducting material can then be quite generally selected within the indicated limits, that is, between a two-digit nanometer size to a three-digit micrometer size.

As already suggested above, both electrical conductors are preferably formed at least in part from metal foil, preferably entirely from metal foil, in order to obtain the thinnest possible heating device over the entire extension of the surface.

According to a further aspect of the present invention, which can be applicable depending on the above-mentioned first aspect, the initially mentioned object can also be attained by means of a generic heating device in which PTC plastic is molded over or around the two electrical conductors in the injection molding process. The electrical conductors can be configured at least in part as a metal foil, so that in this case the above-described advantageous further developments concerning at least one electrical conductor configured in part as a metal foil can also be used on the present further invention aspect.

The two electrical conductors can be molded over or around only locally, for instance if an electrical heating device is desired only at different locations. They can also be molded over or around entirely with PTC plastic, so that both electrical conductors are completely covered by the PTC plastic on at least one side or on both sides.

According to yet another aspect of the present invention, the initially mentioned object can likewise be attained by means of a generic heating device in which the two electrical conductors are applied on a hard shell substrate made of PTC plastic. This aspect, which is basically independent from the previously mentioned aspects, can also be applied with the advantageous further developments of the above-mentioned viewpoints of the object, for instance if at least one electrical conductor is configured at least in part as a metal foil on the hard shell substrate or/and if PTC plastic is molded over the two electrical conductors. It is indeed possible without further ado to apply the two electrical conductors on a hard shell substrate made of PTC plastic and spray PTC plastic over these at the application site, so that they are completely embedded in the PTC plastic.

A complete embedding of the two electrical conductors can also be carried out in a different way by accommodating the two electrical conductors between two hard shell substrates made of PTC plastic.

Regardless of whether PTC plastic is molded over or around the two electrical conductors in the injection molding process or/and if they are applied on a hard shell substrate made a PTC plastic or accommodated between two such hard shell substrates, an assembly formed in this way, which comprises the electrical conductors and the PTC plastic encasing it—regardless of its shape—can be encased at least in part in a plastic film as shell, in order to protect the assembly against outside influences, in particular against the chemical attack of aqueous urea solution.

According to yet another aspect of the invention, the initially mentioned object can also be attained with a generic heating device, in which the two electrical conductors are arranged coaxially, wherein the PTC plastic element is arranged radially between the two electrical conductors, and a plastic shell, which encases the two conductors and the PTC plastic element entirely and extends axially jointly with them, is provided radially outside of the radial outer electrical conductor. The heating device is consequently configured here as a PTC cable with a PTC plastic element between the coaxially arranged electrical conductors. The plastic shell that encases the electrical conductors preferably is resistant to aqueous urea solution.

As initially shown, the present invention also relates to a motor vehicle operating fluid tank with a heating device configured and further developed as described above. Precisely in the case of the last-mentioned approach at attaining the object of a heating device in the form of the PTC cable, the motor vehicle operating fluid tank is preferably provided with cable supporting points, on which the cable-like heating device can be secured. In this way is created the great advantage that a cable-like heating device can be arranged with nearly any desired course, for example, in the form of meanders or loops, such as, for example, overlapping loops with a large surface in the vicinity of the inner wall of the operating fluid tank.

According to a further inventive idea, which can be applied independently of those mentioned above, a heating device for an operating fluid tank can also be formed in that a PTC printing substance is imprinted in a web-like pattern on a foil or on a rigid plate or directly on the surface of the tank shell section. An especially high degree of design freedom is achieved in this way, wherein simultaneously a minimal storage volume of the tank is used to accommodate the heating device in the tank if the heating device is arranged inside the tank. The heating path produced by the imprinting of a PTC plastic applicable by means of printing technology can also be covered in this case by a plastic film as described above, and can thus be protected from the chemical attack of aqueous urea solution. The plastic film can thereby be glued or laminated directly onto the substrate on which the PTC heating path is applied.

### BRIEF DESCRIPTION OF THE DRAWING FIGURES

The present invention will be described in the following with the aid of the enclosed drawings, wherein:

FIG. 1 shows a cross section through a first embodiment of a heating device according to the invention

FIG. 2 shows a cross section through a second embodiment of a heating device according to the invention,

FIG. 3 shows a plan view of a hard shell substrate with electrical conductors provided thereon of a third embodiment of the heating device according to the invention,

FIG. 4 shows a fourth embodiment of the heating device according to the invention, and

FIG. 5 shows a fifth embodiment of a heating device according to the invention, wherein FIG. 5a shows a cross section and FIG. 5b shows a partial longitudinal section through the heating device.

### DETAILED DESCRIPTION OF THE PREFERRED EMBODIMENTS

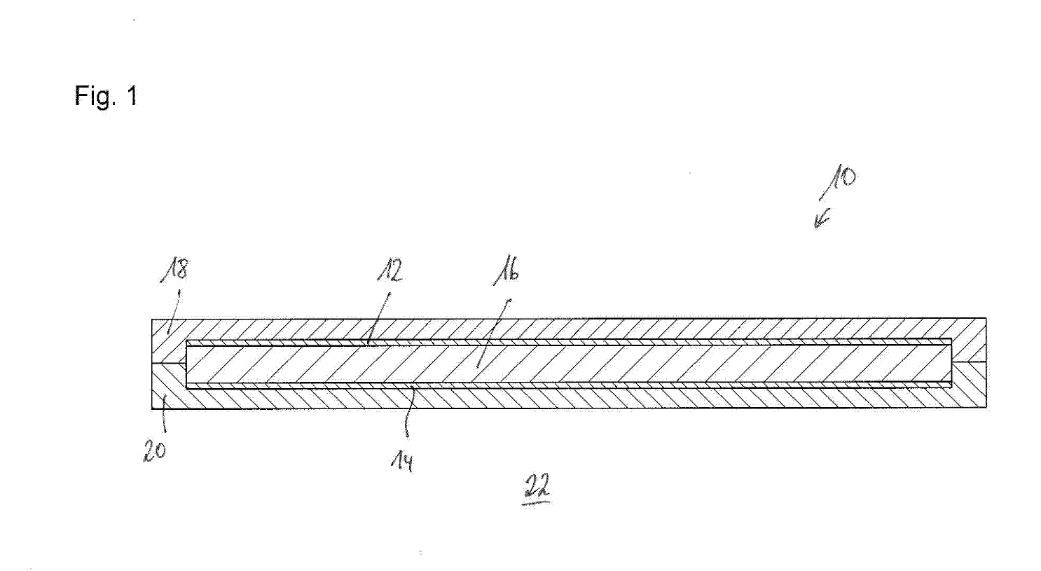

FIG. 1 shows a first embodiment of a heating device according to the invention identified overall with reference numeral 10. The heating device comprises a first metal foil 12 and a second metal foil 14 as electrical conductors and a plastic element 16 made of PTC plastic arranged between the two metal foils 12 and 14. The arrangement of the metal foils 12 and 14 as well as the PTC plastic element 16 is located between the two plastic films 18 and 20, which hermetically shield the electrically conducting components 12, 14, and 16 from the outside environment, so that neither the metal foils 12 and 14 nor the PTC plastic element 16 can be touched or wetted by a medium in the outer environment 22. This is advantageous in particular if the heating device 10 is provided for emitting heat to a substance that is chemically aggressive toward at least one of the materials of the heating device, as is the case, for example, with aqueous urea solution.

The metal foils 12 and 14 are preferably aluminum foils with a thickness of, for example, 20 to 40 μm.

The PTC plastic element 16 preferably has a thickness of approximately 500 μm and is formed from a thermoplastic plastic filled with PTC particles.

The foils 18 and 20 are preferably made from polypropylene. The two metal foils 12 and 14 are each bonded to a different pole of an electric energy source, wherein the supply lines run through the plastic films 18 and 20. The supply lines are not shown in FIG. 1.

The plastic films in the shown example have a thickness of 250 μm, so that the entire heating device 10 has a thickness of a little less than 1.1 mm. They can thus be arranged in the interior space of the tank without the heating device 10 taking up an excessive amount of tank volume, which would then be lacking for storage of the medium for which the tank is intended.

The outer environment 22 is therefore preferably the interior space of a tank.

To facilitate their processability, the metal foils 12 and 14 are bonded to the respective foils 18 and 20, which are in contact with them, that is, even before they are applied on the PTC plastic element 16. The metal foils 12 and 14 can be glued to their allocated plastic film 18 or 20, respectively, with an adhesion agent arranged between them, or can be bonded to the foils by means of a vacuum. The foils 18 and 20 can likewise be glued or laminated to the PTC plastic element 16 at the points where they come into direct contact therewith.

Since the two foils 18 and 20 are preferably made from the same plastic, the foils 18 and 20 can be welded to each other where they come into direct contact.

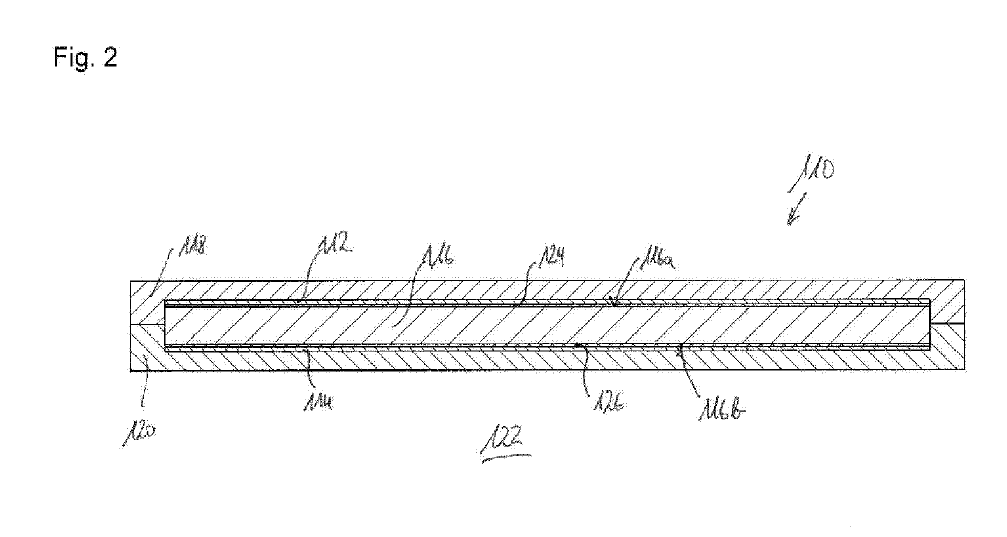

FIG. 2 shows a second embodiment of a heating device according to the invention in the same perspective as in FIG. 1.

Components and component sections that are identical and functionally equivalent to those in the first embodiment are provided with the same reference numeral, but increased by the number 100, in the second embodiment. The second embodiment of FIG. 2 will be described below only to the extent that it differs from the first embodiment in FIG. 1, to whose description reference is expressly made to describe the second embodiment.

The second embodiment differs from the first only in that a metal layer is applied on the surfaces 116a and 116b that face the metal foils 112 and 114, for example, by precipitation from the gas phase, as is possible by means of sputtering, in order to improve the electrical contact between the metal foils 112 and 114, on the one hand, and the PTC plastic element 116, on the other hand. The metal layers 124 and 126 are only a few nanometers thick, as is usual for a metal layer precipitated from a gas phase, but considerably improve the contact between the PTC plastic element 116 and the metal foils 112 and 114, and thus reduce the contact resistance between the indicated components.

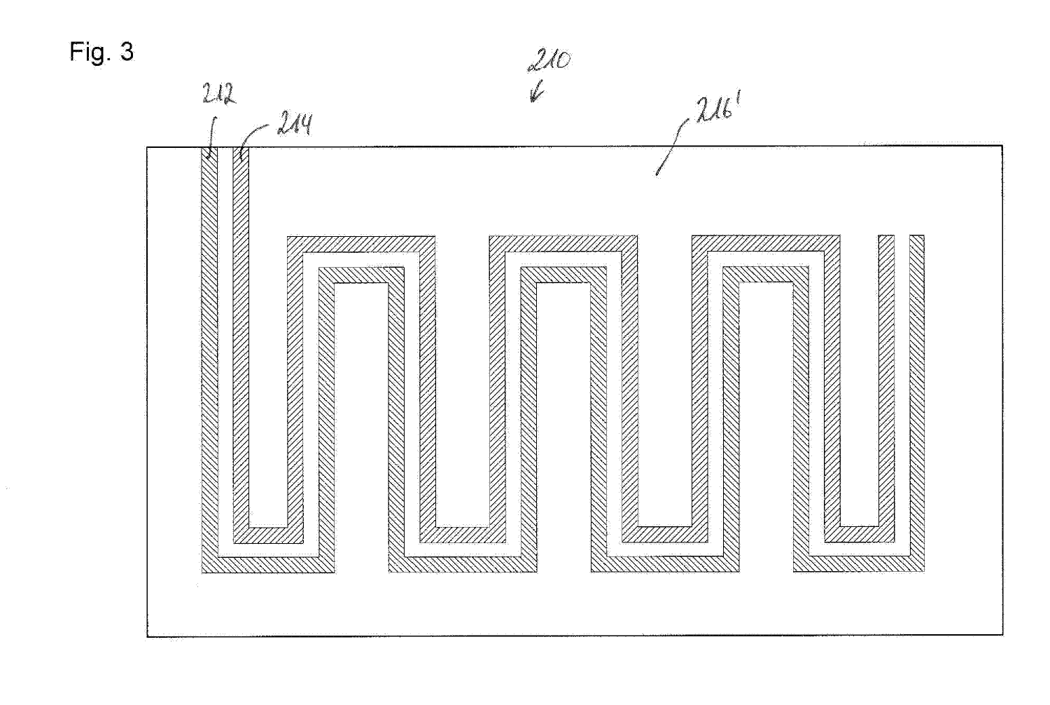

FIG. 3 shows a part of a third embodiment 210 in a plan view.

Components and component section that are identical and functionally equivalent to those in the first or second embodiment are provided with the same reference numbers, but increased by the number 200 or 100, in the third embodiment. The third embodiment of FIG. 3 will be described below only to the extent that it differs from the first embodiment in FIG. 1 or the second embodiment in FIG. 2, to whose description reference is expressly made to describe the third embodiment.

The two electrical conductors 212 and 214 are shown shaded only to better distinguish them from the substrate 216′ which supports them. It is not a sectional representation.

The substrate 216′ can be made from PTC plastic as a 3-dimensional shell component with multiple curves or angles, for example, by means of an injection molding process or as a thermoformed shell component. The electrical conductors 212 and 214 can be applied, preferably again as metal foils, on the surface facing the observer of FIG. 3. The side of the substrate 216′ facing the observer of FIG. 3 can be either molded over with a PTC plastic or can be covered with a second PTC plastic hard shell, whose side facing the substrate 216 is complementary to the surface of the substrate 216′ facing the observer of FIG. 3, so as to completely embed the electrical conductor 212 and 214, in order to bond the two hard shells in a manner that is as gap-free as possible.

FIG. 3 can also show an altered version of an extremely advantageous heating device with the same depiction. The reference 216′ can represent, for example, a cutout of the tank wall of a motor vehicle operating fluid tank, wherein the observer in FIG. 3 faces the side facing toward the tank interior.

The conductor paths 212 and 214 can then be understood as PTC conductor paths of PTC plastic applied on the tank wall 216′. A plastic film, which is not shown in FIG. 3, made again, for example, of polyolefin, in particular polypropylene, can be applied above these, for example, by gluing or lamination on the tank wall 216′, in order to protect the conductor paths 212 and 214 against wetting by the medium to be heated by the heating device 210.

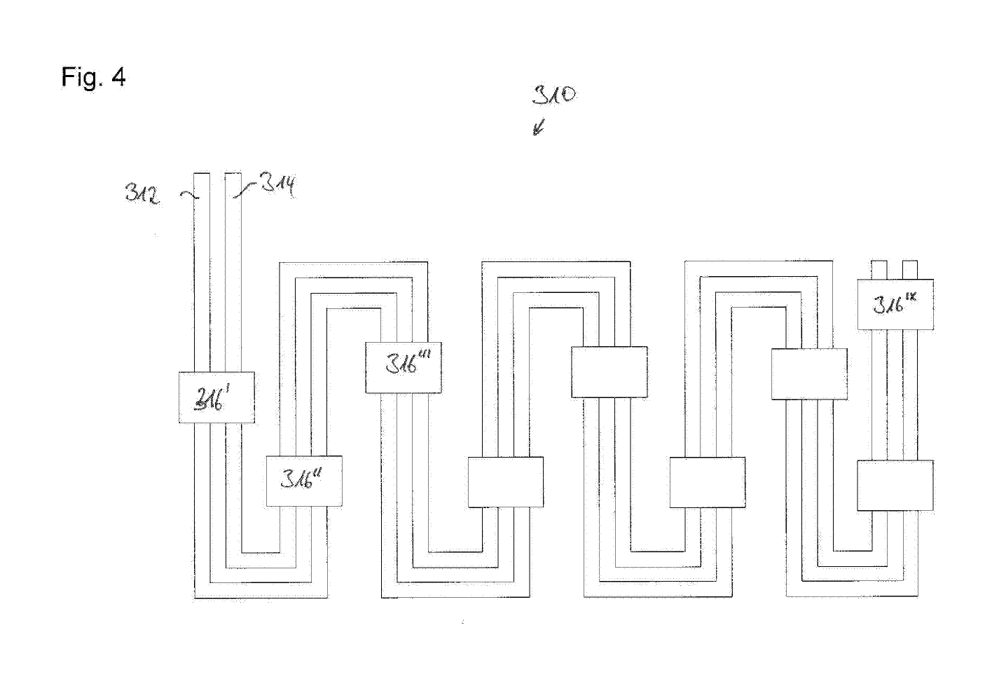

FIG. 4 shows a fourth embodiment of a heating device 410 according to the invention.

Components and component sections that are identical and functionally equivalent to those in the first, second, or third embodiment are provided with the same reference numerals increased by the numbers 300, 200, or 100 in the fourth embodiment. The fourth embodiment of FIG. 4 will be described only to the extent that it differs from the first embodiment in FIG. 1 or the second embodiment in FIG. 2 or the third embodiment in FIG. 3, to whose description reference is expressly made to describe the fourth embodiment.

The heating device 310 of the fourth embodiment shows two electrical conductors 312 and 314, preferably again made from metal foil, which are locally bridged at various points by PTC plastic elements 316′, 316″ . . . 316^{IX}. The PTC plastic elements are here either molded around the electrical conductors 312 and 314 or formed from two half-shells, which locally accommodate sections of the electrical conductors 312 and 314 between them, or encase a hard shell of PTC plastic that supports the electrical conductors 312 and 314 on one side, wherein said hard shell is molded over with PTC plastic for a complete embedding of the conductor sections supported on the hard shell.

The conductor arrangement 312, 314 with the PTC elements 316 locally bridging them can again be covered by a plastic film or can be accommodated between two plastic films. The above-said applies to the plastic films.

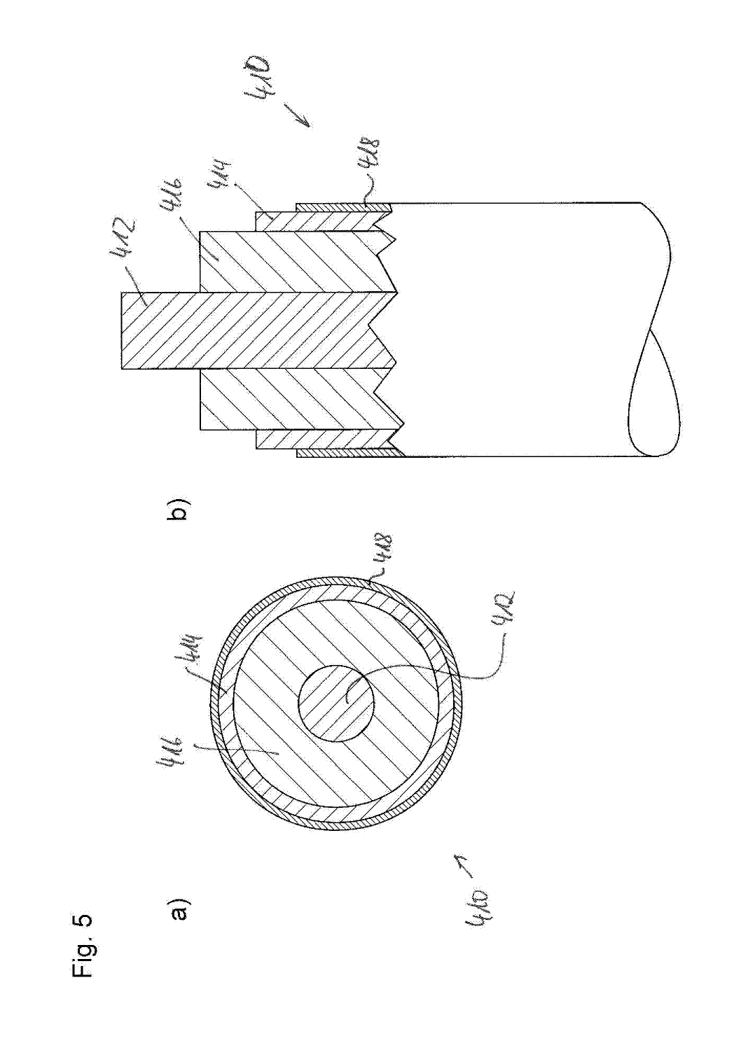

FIG. 5 shows a fifth embodiment 410 of a heating device according to the invention.

Components or component sections that are identical and functionally equivalent to those in the first to fourth embodiments are provided with the same reference numerals, but increased by 400, 300, 200, or 100, in the fifth embodiment. The fifth embodiment of FIG. 5 will be described below only to the extent that it differs from the embodiments in the FIGS. 1 to 4, to whose description reference is expressly made otherwise to describe the fifth embodiment.

FIG. 5a shows here a cross sectional view of the fifth embodiment and FIG. 5b shows a partial longitudinal section view thereof.

Differently from the previous embodiments, the electrical conductors 412 and 414 are arranged here coaxially with respect to each other, while the radial space between the first electrical conductor 412 and the second electrical conductor 414, which encompasses the same on the outside, is entirely filled by a PTC plastic element 416. The coaxial assembly consisting of the first and second electrical conductors 412 and 414 and the PTC plastic element 416 arranged between them are protected radially on the outside by a plastic shell 418 that is resistant to aqueous urea solution and made, for example, from polypropylene.

The coaxial cable-type heating device 410 of the fifth embodiment is preferably flexible so that it can be arranged within the limits of its deformability in a motor vehicle operating fluid tank. Fastening devices can be locally provided for this purpose on the inside of the tank with a separation from one another for local fastening of the coaxial cable-like heating device, for example, in the form of locking clips into which the coaxial cable-like heating device 410 can be pressed. In this way, the heating device 410 having a large heat-emitting surface can be arranged in the motor vehicle operating fluid tank while avoiding all potential mounting obstacles, for example, possibly a fill level sensor or other sensors, such as temperature sensors or quality sensors for an operating fluid pump and the like.

The above presented heating devices are suited especially preferably for heating aqueous urea solution as is used in motor vehicles to reduce nitrogen oxides in the exhaust of an internal combustion engine.

1. A heating device for a motor vehicle operating fluid tank comprising:
at least two electrical conductors;
an element made from PTC plastic arranged between two of said at least two electrical conductors and in electrical contact with said two of said at least two electrical conductors; and
a shell that protects at least sections of the electrical conductors and the PTC plastic element from the outside environment;
wherein at least one of the two of said at least two electrical conductors is formed at least in part from a metal foil, and that the shell is an insulating surface.

2. The heating device according to claim 1,
wherein the section of the electrical conductor formed from the metal foil is a meandering conductor path.

3. The heating device according to claim 1,
wherein the PTC plastic element is made by extrusion or/and injection molding or/and thermoforming from a semi-finished product.

4. The heating device according to claim 1,
wherein the section of the electrical conductor formed from the metal foil is bonded to the insulating surface, by means of an adhesive or/and by means of a vacuum.

5. The heating device according to claim 1,
wherein that the PTC plastic element is formed with one or two metal foils and is bonded to the metal foils by co-extrusion.

6. The heating device according to claim 1,
wherein an electrically conducting material that is different from the PTC plastic is applied on at least one side of the PTC plastic that faces toward an electrical conductor.

7. The heating device according to claim 6,
wherein the electrically conducting material is applied by means of a precipitation process, or by applying a liquid or paste-like electrically conductive substance.

8. The heating device according to claim 1,
wherein both electrical conductors are formed at least in sections.

9. The heating device according to the preamble of claim 1,
wherein the two electrical conductors are molded over or around with PTC plastic in the injection molding process.

10. The heating device according to claim 1,
wherein the two electrical conductors are applied on a hard shell substrate made from PTC plastic.

11. The heating device according to claim 10,
wherein the two electrical conductors are accommodated between two hard shell substrates made from PTC plastic.

12. The heating device according to claim 9,
wherein an assembly comprising the electrical conductors and the PTC plastic which encases them is encased at least in sections by a plastic film.

13. The heating device according to claim 1,
wherein the two electrical conductors are coaxially arranged, wherein the two PTC plastic elements are radially arranged between the two electrical conductors, and an insulating shell, is provided, which fully encases the two conductors and the PTC plastic element and extends axially jointly with them radially outside of the radial outer electrical conductor.

14. A motor vehicle operating fluid tank comprising:
a filling opening;
an extraction opening that is different from the filling opening; and
a heating device having at least two electrical conductors, an element made from PTC plastic arranged between two of said at least two electrical conductors and in electrical contact with said two of said at least two electrical conductors, and a shell that protects at least sections of the electrical conductors and the PTC plastic element from the outside environment, wherein at least one of the two of said at least two electrical conductors is formed at least in part from a metal foil, and that the shell is an insulating surface.

15. The heating device according to claim 1, wherein at least one of the two of said at least two electrical conductors is formed at least in part from aluminum foil.

16. The heating device according to claim 1, wherein the shell comprises an a plastic film bonded to the metal foil.

17. The heating device according to claim 1, wherein the PTC plastic element is made by extrusion or/and injection molding or/and thermoforming from a plate-like semi-finished product.

18. The heating device according to claim 1,
wherein the section of the electrical conductor formed from the metal foil is bonded to the insulating surface configured as a plastic film by means of an adhesive or/and by means of a vacuum.

19. The heating device according to claim 1,
wherein the section of the electrical conductor formed from the metal foil is bonded to the insulating surface configured as a plastic film by means of an electrically conducting adhesive or/and by means of a vacuum.

20. The heating device according to claim 6,
wherein the electrically conducting material is applied by means of chemical or galvanic precipitation or chemical or physical gas phase precipitation, or by applying a liquid or paste-like electrically conductive substance.

21. The heating device according to claim 1,
wherein both electrical conductors are formed completely from a metal foil.

22. The heating device according to claim 9,
wherein an assembly comprising the electrical conductors and the PTC plastic which encases them is encased completely by a plastic film.

23. The heating device according to claim 13 wherein the insulating shell is a plastic shell.
